(19) United States
(12) Patent Application Publication
(10) Pub. No.: US 2020/0147577 A1
(43) Pub. Date: May 14, 2020

(54) Granules

(71) Applicant: 3M INNOVATIVE PROPERTIES COMPANY, St. Paul, MN (US)

(72) Inventors: Jean A. Tangeman, Minneapolis, MN (US); Rebecca L. A. Everman, Falcon Heights, MN (US); Taisiya Skorina, Woodbury, MN (US); Robert P. Brown, Hudson, WI (US); Kenton D. Budd, Woodbury, MN (US)

(21) Appl. No.: 16/620,141

(22) PCT Filed: Jun. 13, 2018
(86) PCT No.: PCT/IB2018/054323

§ 371 Date: Dec. 6, 2019

Related U.S. Application Data
(60) Provisional application No. 62/661,241, filed on Apr. 23, 2018.
(60) Provisional application No. 62/521,640, filed on Jun. 19, 2017.

(51) Int. Cl. B01J 13/14; B01J 13/22

(52) U.S. Cl. CPC B01J 13/14; E04D 2001/005; B01J 13/22

(57) ABSTRACT

Plurality of granules comprising a ceramic core having an outer surface and a shell on and surrounding the core, wherein the shell comprises at least first concentric layers, wherein the first layer comprises first ceramic particles bound together with a first inorganic binder, wherein the first inorganic binder comprises reaction product of at least alkali silicate and hardener, wherein the shell of each granule collectively has a volume of at least 40 volume percent, based on the total volume of the respective granule, and wherein the granules have a minimum Total Solar Reflectance of at least 0.7. The granules are useful, for example, as roofing granules.

### CROSS REFERENCE TO RELATED APPLICATIONS

This application claims the benefit of U.S. Provisional Patent Application Nos. 62/661241, filed Apr. 23, 2018, and 62/521640, filed Jun. 19, 2017, the disclosures of which are incorporated by reference herein in their entireties.

### BACKGROUND

Conventional roofing granules consist of a core baserock of dacite, nepheline syenite, rhyolite, andesite, etc., coated with at least one layer of pigment-containing coating. A typical coating is composed of sodium silicate mixed with raw clay and a pigmenting oxide. Energy efficient shingles are designed to have improved solar reflectivity. Titania pigmented standard white granules are known, but total reflectance of these pigments is limited by absorbance of the baserock (as conventional pigment layers do not completely “hide” the underlying base), and by absorbance in the binder system by components such as the clay.

### SUMMARY

In one aspect, the present disclosure describes a first plurality of granules comprising a ceramic (i.e., comprises at least one ceramic) core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener (in some embodiments further comprising alkali silicate itself), wherein the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first ceramic particles are present in a first weight percent with respect to the total weight of the first layer and the second ceramic particles are present in the second layer of the same granule in a second weight percent with respect to the total weight of the second layer, wherein for a given granule, the first weight percent is greater than the second weight percent, wherein the shell of each granule collectively has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).

In another aspect, the present disclosure describes a second plurality of granules comprising a ceramic core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener (in some embodiments further comprising alkali silicate itself), wherein the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first layer has a first volume percent porosity and the second layer of the same granule has a second volume percent porosity, wherein the first volume percent porosity of the first layer is greater than the second volume percent porosity of the respective second layer, wherein the shell of each granule collectively has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).

In another aspect, the present disclosure describes a third plurality of granules comprising a ceramic core having an outer surface and a shell on and surrounding the core, wherein the shell comprises at least a first concentric, compositional gradient layer, wherein the first layer comprises first ceramic particles bound together with a first inorganic binder, wherein the first inorganic binder comprises reaction product of at least alkali silicate and hardener (in some embodiments further comprising alkali silicate itself), wherein the shell of each granule collectively has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).

In this application:

“amorphous” refers to material that lacks any long-range crystal structure, as determined by the X-ray diffraction technique described in the Examples;

“ceramic” refers to a metal (including silicon) oxide, which may include at least one of a carbon or a nitrogen, in at least one of an amorphous, crystalline, or glass-ceramic form;

“solid ceramic core” refers to a ceramic that is substantially solid (i.e., has no more than 10 percent porosity, based on the total volume of the core);

“functional additive” refers to a material that substantially changes at least one property (e.g., durability and resistance to weathering) of a granule when present in an amount not greater than 10 percent by weight of the granule;

“glass” refers to amorphous material exhibiting a glass transition temperature;

“hardener” refers to a material that initiates and/or enhances hardening of an aqueous silicate solution; hardening implies polycondensation of dissolved silica into three-dimensional Si—O—Si(Al, P) bond network and/or crystallization of new phases; in some embodiments, the granules comprise excess hardener;

“mineral” refers to a solid inorganic material of natural occurrence; and

“partially crystallized” refers to material containing a fraction of material characterized by long range order.

In another aspect, the present disclosure describes a method of making the first and second pluralities of granules described herein, the method comprising:

providing a plurality of ceramic cores;

coating each of the ceramic cores with a first layer precursor, wherein the first layer precursor comprises a first aqueous dispersion comprising the first ceramic particles, the first alkali silicate precursor, and the first hardener precursor;

coating each of the ceramic cores with a second layer precursor, wherein the second layer precursor comprises a second aqueous dispersion comprising the second ceramic particles, the second alkali silicate precursor, and the second hardener precursor; and

curing the coated aqueous dispersion to provide the plurality of granules.

In another aspect, the present disclosure describes a method of making the first and second pluralities of granules described herein, the method comprising:

providing a plurality of ceramic cores;

providing first and second first layer precursors, wherein the first precursor comprises first alkali silicate precursor, first hardener, and first ceramic particles, and wherein the second precursor comprises second alkali silicate precursor, and second hardener, and optionally first or second ceramic particles;

coating each of the ceramic cores with the first and second first layer precursors, wherein initially the first first layer precursor is applied at a higher rate than the second first layer precursor (where initially, for example, zero amount of the second first layer precursor is applied); and

curing the coated aqueous dispersion to provide the plurality of granules.

Granules described herein are useful, for example, as roofing granules.

Advantages of some embodiments of granules described herein may include high TSR (i.e., at least 70%) with low to moderate cost (i.e., $200 to $2000 per ton), low dust (i.e., comparable to conventional roofing granules), low staining (i.e., stain test values less than 10), and good mechanical properties (i.e., tumble toughness values of at least 50).

### BRIEF DESCRIPTION OF THE DRAWINGS

FIGS. 1A and 1B show TSR vs. coating thickness and TSR vs. coating fraction, respectively, for Example 2 samples.

FIGS. 2A-2C show optical images of granules of Example 2 at varying stages of coating thickness.

FIG. 2D shows optical images of granules of Illustrative Example II without a second coating layer.

FIG. 2E shows optical images of granules of Example 2 with a second coating layer.

### DETAILED DESCRIPTION

In some embodiments of pluralities of granules described herein for a given granule, a concentric layer can be contiguous or noncontiguous.

In some embodiments of pluralities of granules described herein having the at least first and second concentric layers, the first ceramic particles are present in the first layer in a first weight percent with respect to the total weight of the first layer and the second ceramic particles are present in the second layer of the same granule in a second weight percent with respect to the total weight of the second layer, wherein for a given granule, the first weight percent is greater than the second weight percent. In some embodiments, for a given granule, the first weight percent is in a range from 30 to 90, (in some embodiments, in a range from 40 to 80, 50 to 80, or even 60 to 80) weight percent with respect to the first layer, and wherein for the same granule, the second weight percent is in a range from 0 to 50, (in some embodiments, in a range from 10 to 40, 10 to 30, or even 5 to 25; in some embodiments, zero) weight percent with respect to the second layer.

In some embodiments of pluralities of granules described herein having the at least first and second concentric layers, for a given granule, the first layer has a first volume percent porosity and the second layer of the same granule has a second volume percent porosity, wherein the first volume percent porosity of the first layer is greater than the second volume percent porosity of the respective second layer. In some embodiments, for a given granule, the first volume percent porosity is in a range from 20 to 70, (in some embodiments, in a range from 20 to 60, 25 to 50, or even 30 to 45) volume percent with respect to the first layer, and wherein for the same granule, the second volume percent porosity is in a range from 0 to 40, (in some embodiments, in a range from 0 to 30, 0 to 20, or even 0 to 10; in some embodiments, zero) volume percent with respect to the second layer. Porosity as described above is typically associated with voids (that are not, for example, not filled with binder) between and among ceramic particles. Such voids are typically useful for scattering and reflecting solar radiation. The volume percent porosity as described above is measured using, mercury porosimetry, as described in the Examples. Although not wanting to be bound by theory, very fine nanoscale porosity (e.g., with pore diameters less than about 50 nanometers), if present, typically originates within the binder phase, is much less effective for scattering solar radiation, and is not included in the volume percent porosity amounts recited above.

In some embodiments of pluralities of granules described herein, for a given granule, a third layer is disposed between the core and the first layer (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself). In some embodiments, for a given granule, a fourth layer is disposed between the first and second layers (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself).

In some embodiments of pluralities of granules described herein, for a given granule, a third layer is disposed between the first and second layers (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself). In some embodiments, for a given granule, a fourth layer is disposed between the core and the first layer (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself).

In some embodiments of pluralities of granules described herein, wherein for a given granule, the first and second layers have a first and second average thickness respectively, and wherein for the same granule, the first average thickness is greater than the second average thickness. Average thickness is determined from an image (for example, an image from SEM, an optical microscope, or an SEM compositional map obtained using XRF) of a cross section of a granule. In some embodiments, the first average thickness is at least 50 (in some embodiments, at least 75, 100, 250, 500, or even at least 1000; in some embodiments, in a range from 50 to 1000, 100 to 500, or even 150 to 250) micrometers. In some embodiments, the second average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometers.

In some embodiments of the third plurality of granules within the first compositional gradient layer there is a first average concentration of the first ceramic particles for a first region comprising at least 5 volume percent of the shell at a first average distance from the core of a granule, and a second average concentration of the first ceramic particles for a second region comprising at least 5 volume percent of the shell at a second, further average distance from the core of a granule, wherein the first average concentration is greater than the second average concentration.

In some embodiments of the third plurality of granules within the first compositional gradient layer there is a first average volume percent porosity for a first region comprising at least 5 volume percent of the shell at a first average distance from the core of a granule, and a second average volume percent porosity for a second region comprising at least 5 volume percent of the shell at a second, further average distance from the core of a granule, wherein the first average volume percent porosity is greater than the second average volume percent porosity.

Some embodiments of the third plurality of granules further comprises a second layer. In some embodiments, the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself). In some embodiments, for a given granule, a third layer is disposed between the core and the first layer (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)). In some embodiments, for a given granule, a fourth layer is disposed between the first and second layers (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).

In some embodiments of pluralities of granules described herein, the ceramic cores include solid ceramic cores. In some embodiments the core has a diameter of at least 200 micrometers (in some embodiments, at least 250 micrometers, 300 micrometers, 400 micrometers, 500, micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).

In some embodiments, the core comprises at least one of a silicate (e.g., silicate rock) (e.g., aluminosilicate (including aluminosilicate rock) and alkali aluminosilicate (including alkali aluminosilicate rock)), aluminate (including aluminate rock) (e.g., bauxite), or silica. Typically, the core is at least one of a crystalline, a glass, or a glass-ceramic. Such materials can be obtained from conventional roofing granule sources known in the art. Further crystalline, glass, or glass-ceramic materials can be made using techniques known in the art.

In some embodiments of pluralities of granules described herein, the core has no more than 10, 5, 4, 3, 2, 1, or even has zero percent porosity, based on the total volume of the core.

Typically, the shell has an average thickness of at least 50 (in some embodiments, at least 75, 100, 150, 200, 250, 300, 350, 400, 500, or even 750; in some embodiments, in a range from 50 to 750, 100 to 500, or even 200 to 500) micrometers.

In some embodiments of pluralities of granules described herein, the shell of each granule collectively comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the shell of the respective granule.

In some embodiments of pluralities of granules described herein, the shell comprises a first and second concentric layers, with the first layer being closer to the core than the second layer. In some embodiments, the first layer has an average thickness of at least 50 (in some embodiments, at least 75, 100, 150, 200, 250, 300, 350, 400, 500, or even 750; in some embodiments, in a range from 50 to 750, 100 to 500, or even 200 to 500) micrometers. In some embodiments, the second layer has an average thickness at least 1 (in some embodiments, at least 2, 3, 4, 5, 10, 15, 20, 25, 50, 75, 100, 150, 200, 250, 300, 350, 400, 500, or even 750; in some embodiments, in a range from 1 to 750, 1 to 500, 1 to 250, 1 to 100, 50 to 750, 100 to 750, 200 to 750, 50 to 500, 100 to 500, or even 200 to 500) micrometer.

Suitable alkali silicates include cesium silicate, lithium silicate, a potassium silicate, or a sodium silicate. Exemplary alkali silicates are commercially available, for example, from PQ Corporation, Malvern, Pa. In some embodiments, the inorganic binder further comprises reaction product of amorphous aluminosilicate hardener.

In some embodiments of pluralities of granules described herein, the hardener is at least one an aluminum phosphate, an aluminosilicate, a cryolite, a calcium salt (e.g., CaCl₂), or a calcium silicate. In some embodiments, the hardener may further comprise zinc borate. In some embodiments, the hardener is amorphous. Exemplary hardeners are commercially available, for example, from commercial sources such as Budenheim Inc., Budenheim, Germany, and Solvay Fluorides, LLC, Houston, Tex.

In some embodiments of pluralities of granules described herein, the first and second inorganic binders are the same. Same inorganic binder means the same alkali silicate(s) and same hardeners are present in the same ratios. Same alkali means the same alkali element(s). Same hardener means the average amount of each element that is present in an amount greater than 10 wt. % based on the total weight of the hardener, the average amount of each phase that is present in an amount greater than 10 volume percent, the density, the mean particle size, and the mean crystallite size, are each within 10% of the average value of each other for respective hardeners. For example, if a first hardener consists of an average of 40 wt. % Si, then a second hardener must have an average silica content in a range from 36 wt. % to 44 wt. % to be considered the same. Further, the ratio of total moles of alkali ions to silicon ions, the ratio of each alkali to each additional alkali (if present), and the ratio of hardener solids to alkali silicate solids are all within 10% of each other for respective inorganic binders (i.e., a Si to alkali mole ratio of between 1.8 and 2.2 is within 10% of a ratio of 2.0). In some embodiments of pluralities of granules described herein, the first and second inorganic binders are different (i.e., not the same).

In some embodiments of pluralities of granules described herein, the inorganic binder is present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule.

In some embodiments of pluralities of granules described herein, the ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble. In some embodiments, the ceramic particles comprise mineral. Exemplary sources of ceramic particles include Vanderbilt Minerals, LLC, Norwalk, Conn.; Dadco, Lausanne, Switzerland; American Talc Company, Allamoore, Tex; Imerys, Inc., Cockeysville, Md; and Cristal Metals, Woodridge, Ill.

In some embodiments of pluralities of granules described herein where the second ceramic particles are present, the first and second ceramic particles are the same. “Same ceramic particles” means the average amount of each element that is present in an amount greater than 10 wt. % based on the total weight of the ceramic particles, the average amount of each phase that is present in an amount greater than 10 volume percent, the density, the mean particle size, and the mean crystallite size, are each within 10% of the average value of each other for respective ceramic particles. For example, if first ceramic particles consist of an average of 40 wt. % Si, then second ceramic particles must have an average silica content in a range from 36 wt. % to 44 wt. % to be considered the same.

In some embodiments of pluralities of granules described herein where the second ceramic particles are present, the first and second ceramic particles are different.

In some embodiments, the ceramic particles of each granule comprise no greater than 10 (in some embodiments, no greater than 5, 4, 3, 2, 1, or even zero) percent by weight pure TiO₂, based on the total weight of the granule. In some embodiments, the ceramic particles of each granule comprise no greater than 10 (in some embodiments, no greater than 5, 4, 3, 2, 1, or even zero) percent by weight pure Al₂O₃, based on the total weight of the granule.

In some embodiments of pluralities of granules described herein, the ceramic particles have an average size in a range from 200 nanometers to 200 micrometers (in some embodiments, in a range from 200 nanometers to 100 micrometers, 250 nanometers to 50 micrometers, 500 nanometers to 20 micrometers, 1 micrometers to 10 micrometers, or even 2 micrometers to 20 micrometers). In some embodiments, the ceramic particles have a continuous or bimodal distribution of sizes. In some embodiments, the ceramic particles may have a broad distribution of particle sizes, while in others, it may have a narrow distribution of particle sizes.

In some embodiments of pluralities of granules described herein, at least one of the first or second ceramic particles independently each have a longest dimension, wherein the granules each have a longest dimension, and wherein the longest dimension of each ceramic particle for a given granule is no greater than 10% (in some embodiments, no greater than 20%) of the longest dimension of said given granule.

In some embodiments of pluralities of granules described herein, the granules further comprise at least one of a functional additive (e.g., rheology modifier, durability modifier, and fluxing agent), organic binder, or pigment. Exemplary rheology modifiers include surfactants. Exemplary durability modifiers include nanosilica, pyrogenic (“fumed”) silica, and silica fume, which are available, for example, from Evonik Industries, Essen, Germany.

Exemplary fluxing agents include borax, which is available, for example, from Rio Tinto Minerals, Boron, Calif. Exemplary organic binders include dextrin and carboxymethylcellulose, which are available, for example, from Dow Chemical Company, Midland, Mich.

The first and second pluralities of granules described herein can be made, for example by a method comprising:

providing a plurality of ceramic cores;

coating each of the ceramic cores with a first layer precursor, wherein the first layer precursor comprises a first aqueous dispersion comprising the first ceramic particles, the first alkali silicate precursor, and the first hardener precursor;

coating each of the ceramic cores with a second layer precursor, wherein the second layer precursor comprises a second aqueous dispersion comprising the second ceramic particles, the second alkali silicate precursor, and the second hardener precursor; and

curing the coated aqueous dispersion to provide the plurality of granules. In some embodiments, curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min. In some embodiments, the feeding is over a period of time in a range from 5 minutes to 500 minutes. In some embodiments, the heating is at a temperature in a range from 50° C. to 200° C.

In some embodiments, wherein water is present in the first and second aqueous dispersions in each independently up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective aqueous dispersion.

In some embodiments, coating the ceramic core with the shell comprises fluidized bed coating. In some embodiments, the fluidized bed coating comprises fluidizing ceramic cores, heating the bed of fluidized cores, and continuously feeding the aqueous dispersion into the fluidized bed.

The third plurality of granules described herein can be made, for example, by a method comprising:

providing a plurality of ceramic cores;

providing first and second first layer precursors, wherein the first precursor comprises first alkali silicate precursor, first hardener, and first ceramic particles, and wherein second precursor comprises second alkali silicate precursor, and second hardener, and optionally second ceramic particles;

coating each of the ceramic cores with the first and second first layer precursors, wherein initially the first first layer precursor is applied at a higher rate than the second first layer precursor (where initially, for example, zero amount of the second first layer precursor is applied); and

curing the coated precursors to provide the plurality of granules. In some embodiments, the curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min. In some embodiments, the heating is at a temperature in a range from 50° C. to 200° C.

In some embodiments, wherein water is present in the first and second precursors in each independently up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective precursors.

In some embodiments of pluralities of granules described herein, the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeters to 5 millimeters).

In some embodiments, the inorganic binder is amorphous. In some embodiments, the inorganic binder is partially crystallized.

In some embodiments of pluralities of granules described herein, the granules have a density in a range from 0.5 g/cm³ to 3 g/cm³.

Shaped granules can be formed, for example, by using shaped cores. Granules described herein may be in any of a variety of shapes, including cubes, truncated cubes, pyramids, truncated pyramids, triangles, tetrahedra, spheres, hemispheres, and cones. In some embodiments, a granule can have a first face and a second face separated by an average thickness. In some embodiments, such granules further comprise at least one of a straight or sloping wall.

In some embodiments of pluralities of granules described herein, the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.

In some embodiments of pluralities of granules described herein, the granules have a Stain Value (as determined by the Stain Value Test described in the Examples) of not greater than 15 (in some embodiments, not greater than 10, 5, 4, 3, 2, 1, or even not greater than 0.5).

In some embodiments, the granules further comprise at least one adhesion promoter (e.g., a polysiloxane). The polysiloxane can contain a hydrocarbon tail for better wetting with the hydrophobic asphalt. A siloxane bond can form, for example, between a granule surface and the polysiloxane, via condensation reaction, leaving the hydrophobic hydrocarbon tail on the granule surface. Although not wanting to be bound by theory, the transformation of the hydrophilic surface into a hydrophobic oily surface improves wetting of the granule surface by the asphalt. Exemplary polysiloxanes include “SILRES BS 60” or “SILRES BS 68” from Wacker Chemical Corporation, Adrian, Mich.

In some embodiments of pluralities of granules described herein, the granules further comprise at least one dust suppressant (e.g., an acrylic polymer comprising a quaternary ammonium moiety and a nonionic monomer). Although not wanting to be bound by theory, dust suppressant is believed to suppress dust through ionic interaction of the positively charged quaternary ammonium moiety and negatively charged dust particles. The quaternary ammonium moiety may also form, for example, an ionic bond with natural mineral. Furthermore, it may ionically bond with ionic species in asphalt, particularly polyphosphoric acid (PPA) added asphalt. Of course, other anionic species are present in asphalt, including non-PPA asphalt, to which an ionic bond may form. Accordingly, a dust suppression coating composition comprising a quaternary ammonium compound as described herein may also serve as an adhesion promoter.

In some embodiments of pluralities of granules described herein, the dust suppression coating polymer comprises water-based polymers, such as a polyacrylate (e.g., an acrylic emulsion polymer). In some embodiments, the coating polymer is a polymer such as described in PCT Pat. Pub. Docs. WO2015157615 A1, and WO2015157612 A1, published Oct. 15, 2015, the disclosures of which are incorporated herein by reference.

Granules described herein are useful, for example, as roofing granules. For example, granules described herein can be used to make roofing material (e.g., a shingle) comprising a substrate and the granules thereon. In some embodiments, the roofing material has a Total Solar Reflectance (TSR) (as determined by the Total Solar Reflectance Test described in the Examples) of at least 60 (in some embodiments, at least 63, 65, or even at least 70) %.

Advantages of embodiments of granules described herein may include high TSR (i.e., at least 70%) with low to moderate cost (i.e., $200 to $2000 per ton), low dust (i.e., comparable to conventional roofing granules), low staining (i.e., stain test values of less than 10), and good mechanical properties (i.e., tumble toughness values of at least 50).

### Exemplary Embodiments

1A. A plurality of granules comprising a ceramic core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener (in some embodiments further comprising alkali silicate itself), wherein the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first ceramic particles are present in a first weight percent with respect to the total weight of the first layer and the second ceramic particles are present in the second layer of the same granule in a second weight percent with respect to the total weight of the second layer, wherein for a given granule, the first weight percent is greater than the second weight percent, wherein the shell of each granule collectively has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).
2A. The plurality of granules of Exemplary Embodiment 1A, wherein for a given granule, the first weight percent is in a range from 30 to 90, (in some embodiments, in a range from 40 to 80, 50 to 80, or even 60 to 80) weight percent with respect to the first layer, and wherein for the same granule, the second weight percent is in a range from 0 to 50, (in some embodiments, in a range from 10 to 40, 10 to 30, or even 5 to 25; in some embodiment, zero) weight percent with respect to the second layer.
3A. The plurality of granules of any preceding A Exemplary Embodiment, wherein for a given granule, the first layer has a first volume percent porosity and the second layer of the same granule has a second volume percent porosity, wherein the first volume percent porosity of the first layer is greater than the second volume percent porosity of the respective second layer.
4A. The plurality of granules of Exemplary Embodiment 3A, wherein for a given granule, the first volume percent porosity is in a range from 20 to 70, (in some embodiments, in a range from 20 to 60, 25 to 50, or even 30 to 45) volume percent with respect to the first layer, and wherein for the same granule, the second volume percent porosity is in a range from 0 to 40, (in some embodiments, in a range from 0 to 30, 0 to 20, or even 0 to 10; in some embodiments, zero) volume percent with respect to the second layer.
5A. The plurality of granules of any preceding A Exemplary Embodiment, wherein for a given granule, the first and second layers are independently contiguous or noncontiguous.
6A. The plurality of granules of any preceding A Exemplary Embodiment, wherein for a given granule, a third layer is disposed between the core and the first layer (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)).
7A. The plurality of granules of Exemplary Embodiment 6A, wherein for a given granule, a fourth layer is disposed between the first and second layers (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).
8A. The plurality of granules of any preceding A Exemplary Embodiment, wherein for a given granule, a third layer is disposed between the first and second layers (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself).
9A. The plurality of granules of Exemplary Embodiment 8A, wherein for a given granule, a fourth layer is disposed between the core and the first layer (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).
10A. The plurality of granules of any preceding A Exemplary Embodiment, wherein for a given granule, the first and second layers have a first and second average thickness respectively, and wherein for the same granule, the first average thickness is greater than the second average thickness.
11A. The plurality of granules of Exemplary Embodiment 10A, wherein, the first average thickness is at least 50 (in some embodiments, at least 75, 100, 250, 500, or even at least 1000; in some embodiments, in a range from 50 to 1000, 100 to 500, or even 150 to 250) micrometers.
12A. The plurality of granules of either Exemplary Embodiment 9A or 10A, wherein, the second average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometers.
13A. The plurality of granules of any preceding A Exemplary Embodiment, wherein the ceramic cores include solid ceramic cores.
14A. The plurality of granules of any preceding A Exemplary Embodiment, wherein the core has a diameter of at least 200 micrometers (in some embodiments, at least 250 micrometers, 300 micrometers, 400 micrometers, 500 micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).
15A. The plurality of granules of any preceding A Exemplary Embodiment, wherein the core is at least one of a crystalline, glass, or a glass-ceramic.
16A. The plurality of granules of any preceding A Exemplary Embodiment, wherein the core comprises at least one of a silicate (e.g., silicate rock) (e.g., aluminosilicate (including aluminosilicate rock) and alkali aluminosilicate (including alkali aluminosilicate rock)), aluminate (including aluminate rock) (e.g., bauxite), or silica.
17A. The plurality of granules of any preceding A Exemplary Embodiment, wherein the shell has an average thickness of at least 50 (in some embodiments, at least 75, 100, 150, 200, 250, 300, 350, 400, 500, or even 750; in some embodiments, in a range from 50 to 750, 100 to 500, or even 200 to 500) micrometers.
18A. The plurality of granules of any preceding A Exemplary Embodiment, wherein the shell of each granule comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the shell of the respective granule.
19A. The plurality of granules of any preceding A Exemplary Embodiment, wherein at least one of the first or second ceramic particles independently each have a longest dimension, wherein the granules each have a longest dimension, and wherein the longest dimension of each ceramic particle for a given granule is no greater than 10% (in some embodiments, no greater than 20%) of the longest dimension of said given granule.
20A. The plurality of granules of any of Exemplary Embodiments 1A to 18A, wherein the ceramic particles of each granule collectively comprise no greater than 10 (in some embodiments, no greater than 5, 4, 3, 2, 1, or even zero) percent by weight TiO₂, based on the total weight of the granule.
21A. The plurality of granules of any preceding A Exemplary Embodiment, wherein the ceramic particles of each granule collectively comprise no greater than 10 (in some embodiments, no greater than 5, 4, 3, 2, 1, or even zero) percent by weight pure Al₂O₃, based on the total weight of the granule.
22A. The plurality of granules of any preceding A Exemplary Embodiment, wherein the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.
23A. The plurality of granules of any preceding A Exemplary Embodiment, wherein the inorganic binder is collectively present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule.
24A. The plurality of granules of any preceding A Exemplary Embodiment, wherein the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeters to 5 millimeters).
25A. The plurality of granules of any preceding A Exemplary Embodiment, wherein the at least one of the first or second ceramic particles independently have an average size in a range from 200 nanometers to 200 micrometers (in some embodiments, in a range from 200 nanometers to 100 micrometers, 250 nanometers to 50 micrometers, 500 nanometers to 20 micrometers, 1 micrometers to 10 micrometers, or even 2 micrometers to 20 micrometers).
26A. The plurality of granules of any preceding A Exemplary Embodiment, wherein at least one of the first or second ceramic particles have a bimodal distribution of sizes.
27A. The plurality of granules of any preceding A Exemplary Embodiment, wherein at least one of the first or second inorganic binders is amorphous.
28A. The plurality of granules of any of Exemplary Embodiments 1A to 26A, wherein at least one of the first or second inorganic binders is partially crystallized.
29A. The plurality of granules of any preceding A Exemplary Embodiment, wherein at least one of the first or second alkali silicates is at least one of a cesium silicate, lithium silicate, a potassium silicate, or a sodium silicate.
30A. The plurality of granules of any preceding A Exemplary Embodiment, wherein the at least one of the first or second hardeners is amorphous.
31A. The plurality of granules of any preceding A Exemplary Embodiment, wherein the at least one of the first or second hardener is at least one of an aluminum phosphate, an aluminosilicate, a cryolite, a calcium salt (e.g., CaCl₂), or a calcium silicate.
32A. The plurality of granules of any preceding A Exemplary Embodiment, wherein the at least one of the first or second ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble.
33A. The plurality of granules of any preceding A Exemplary Embodiment, wherein the at least one of the first or second ceramic particles comprise mineral.
34A. The plurality of granules of any preceding A Exemplary Embodiment, wherein the granules further comprise at least one of a functional additive (e.g., rheology modifier (e.g., surfactant), durability modifier (e.g., nanosilica), and fluxing agent), organic binder, or pigment.
35A. The plurality of granules of any preceding A Exemplary Embodiment, wherein each respective granule has a density in a range from 0.5 g/cm³ to 3 g/cm³.
36A. The plurality of granules of any preceding A Exemplary Embodiment, wherein the granules are in at least one of the following shapes: cubes, truncated cubes, pyramids, truncated pyramids, triangles, tetrahedras, spheres, hemispheres, or cones.
37A. The plurality of granules of any preceding A Exemplary Embodiment, wherein each granule has a first face and a second face separated by a thickness.
38A. The plurality of granules of Exemplary Embodiment 37A, wherein at least some granules further comprise at least one of a straight or sloping wall.
39A. The plurality of granules of any preceding A Exemplary Embodiment, wherein the granules have a Stain Value not greater than 15 (in some embodiments, not greater than 10, 5, 4, 3, 2, 1, or even not greater than 0.5).
40A. The plurality of granules of any preceding A Exemplary Embodiment, further comprising at least one adhesion promoter.
41A. The plurality of granules of Exemplary Embodiment 40A, wherein the adhesion promotor comprises a polysiloxane.
42A. The plurality of granules of any preceding A Exemplary Embodiment, further comprising at least one dust suppressant.
43A. The plurality of granules of Exemplary Embodiment 42A, wherein the dust suppressant comprises an acrylic polymer comprising a quaternary ammonium moiety and a nonionic monomer.
44A. The plurality of granules of any preceding A Exemplary Embodiment, wherein the second ceramic particles are present and wherein the first and second ceramic particles are the same.
45A. The plurality of granules of any of Exemplary Embodiments 1A to 43A, wherein the second ceramic particles are present and wherein the first and second ceramic particles are different.
46A. The plurality of granules of any preceding A Exemplary Embodiment, wherein the first and second inorganic binders are the same.
47A. The plurality of granules of any of Exemplary Embodiments 1A to 45A, the first and second inorganic binders are different.
1B. A roofing material (e.g., a shingle) comprising the plurality of granules of any preceding A Exemplary Embodiment.
2B. A roofing material of Exemplary Embodiment 1B having a Total Solar Reflectance (TSR) (as determined by the Total Solar Reflectance Test described in the Examples) of at least 60 (in some embodiments, at least 63, 65, or or even at least 70) %.
1C. A method of making the plurality of granules of any preceding A Exemplary Embodiment, the method comprising:

providing a plurality of ceramic cores;

coating each of the ceramic cores with a first layer precursor, wherein the first layer precursor comprises a first aqueous dispersion comprising the first ceramic particles, the first alkali silicate precursor, and the first hardener precursor;

coating each of the ceramic cores with a second layer precursor, wherein the second layer precursor comprises a second aqueous dispersion comprising the second ceramic particles, the second alkali silicate precursor, and the second hardener precursor; and

curing the coated aqueous dispersion to provide the plurality of granules.
2C. The method of Exemplary Embodiment 1C, wherein the ceramic cores include solid ceramic cores.
3C. The method of either Exemplary Embodiment 1C or 2C, wherein the curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min.
4C. The method of any preceding C Exemplary Embodiment, wherein water is present in the first and second aqueous dispersions in each independently up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective aqueous dispersion.
5C. The method of any preceding C Exemplary Embodiment, wherein coating the ceramic core with the shell comprises fluidized bed coating.
6C. The method of Exemplary Embodiment 5C, wherein the fluidized bed coating comprises fluidizing ceramic cores, heating the bed of fluidized cores, and continuously feeding the aqueous dispersion into the fluidized bed.
7C. The method of Exemplary Embodiment 5C, wherein said feeding is over a period of time in a range from 5 minutes to 500 minutes.
8C. The method of Exemplary Embodiments 6C or 7C, wherein said heating is at a temperature in a range from 50° C. to 200° C.
1D. A plurality of granules comprising a ceramic core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener (in some embodiments further comprising alkali silicate itself), wherein the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first layer has a first volume percent porosity and the second layer of the same granule has a second volume percent porosity, wherein the first volume percent porosity of the first layer is greater than the second volume percent porosity of the respective second layer, wherein the shell of each granule collectively has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).
2D. The plurality of granules of Exemplary Embodiment 1D, wherein for a given granule, the first volume percent porosity is in a range from 20 to 70, (in some embodiments, in a range from 20 to 60, 25 to 50, or even 30 to 45) volume percent with respect to the first layer, and wherein for the same granule, the second volume percent porosity is in a range from 0 to 40, (in some embodiments, in a range from 0 to 30, 0 to 20, or even 0 to 10; in some embodiments, zero) volume percent with respect to the second layer.
3D. The plurality of granules of any preceding D Exemplary Embodiment, wherein for a given granule, the first ceramic particles are present in a first weight percent with respect to the total weight of the first layer and the second ceramic particles are present in the second layer of the same granule in a second weight percent with respect to the total weight of the second layer, wherein for a given granule, the first weight percent is greater than the second weight percent.
4D. The plurality of granules of Exemplary Embodiment 3D, wherein for a given granule, the first weight percent is in a range from 30 to 90, (in some embodiments, in a range from 40 to 80, 50 to 80, or even 60 to 80) weight percent with respect to the first layer, and wherein for the same granule, the second weight percent is in a range from 0 to 50, (in some embodiments, in a range from 10 to 40, 10 to 30, or even 5 to 25; in some embodiment, zero) weight percent with respect to the second layer.
5D. The plurality of granules of any preceding D Exemplary Embodiment, wherein for a given granule, the first and second layers are independently contiguous or noncontiguous.
6D. The plurality of granules of any preceding D Exemplary Embodiment, wherein for a given granule, a third layer is disposed between the core and the first layer (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)).
7D. The plurality of granules of Exemplary Embodiment 6D, wherein for a given granule, a fourth layer is disposed between the first and second layers (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself).
8D. The plurality of granules of any preceding D Exemplary Embodiment, wherein for a given granule, a third layer is disposed between the first and second layers (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)).
9D. The plurality of granules of Exemplary Embodiment 8D, wherein for a given granule, a fourth layer is disposed between the core and the first layer (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).
10D. The plurality of granules of any preceding D Exemplary Embodiment, wherein for a given granule, the first and second layers have a first and second average thickness respectively, and wherein for the same granule, the first average thickness is greater than the second average thickness.
11D. The plurality of granules of Exemplary Embodiment 10D, wherein, the first average thickness is at least 50 (in some embodiments, at least 75, 100, 250, 500, or even at least 1000; in some embodiments, in a range from 50 to 1000, 100 to 500, or even 150 to 250) micrometers.
12D. The plurality of granules of either Exemplary Embodiment 9D or 10D, wherein, the second average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometers.
13D. The plurality of granules of any preceding D Exemplary Embodiment, wherein the ceramic cores include solid ceramic cores.
14D. The plurality of granules of any preceding D Exemplary Embodiment, wherein the core has a diameter of at least 200 micrometers (in some embodiments, at least 250 micrometers, 300 micrometers, 400 micrometers, 500 micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).
15D. The plurality of granules of any preceding D Exemplary Embodiment, wherein the core is at least one of a crystalline, glass, or a glass-ceramic.
16D. The plurality of granules of any preceding D Exemplary Embodiment, wherein the core comprises at least one of a silicate (e.g., silicate rock) (e.g., aluminosilicate (including aluminosilicate rock) and alkali aluminosilicate (including alkali aluminosilicate rock)), aluminate (including aluminate rock) (e.g., bauxite), or silica.
17D. The plurality of granules of any preceding D Exemplary Embodiment, wherein the shell has an average thickness of at least 50 (in some embodiments, at least 75, 100, 150, 200, 250, 300, 350, 400, 500, or even 750; in some embodiments, in a range from 50 to 750, 100 to 500, or even 200 to 500) micrometers.
18D. The plurality of granules of any preceding D Exemplary Embodiment, wherein the shell of each granule comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the shell of the respective granule.
19D. The plurality of granules of any preceding D Exemplary Embodiment, wherein at least one of the first or second ceramic particles independently each have a longest dimension, wherein the granules each have a longest dimension, and wherein the longest dimension of each ceramic particle for a given granule is no greater than 10% (in some embodiments, no greater than 20%) of the longest dimension of said given granule.

20D. The plurality of granules of any of Exemplary Embodiments 1D to 18D, wherein the ceramic particles of each granule collectively comprise no greater than 10 (in some embodiments, no greater than 5, 4, 3, 2, 1, or even zero) percent by weight TiO₂, based on the total weight of the granule.
21D. The plurality of granules of any preceding D Exemplary Embodiment, wherein the ceramic particles of each granule collectively comprise no greater than 10 (in some embodiments, no greater than 5, 4, 3, 2, 1, or even zero) percent by weight pure Al₂O₃, based on the total weight of the granule.
22D. The plurality of granules of any preceding D Exemplary Embodiment, wherein the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.
23D. The plurality of granules of any preceding D Exemplary Embodiment, wherein the inorganic binder is collectively present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule.
24D. The plurality of granules of any preceding D Exemplary Embodiment, wherein the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeters to 5 millimeters).
25D. The plurality of granules of any preceding D Exemplary Embodiment, wherein the at least one of the first or second ceramic particles independently have an average size in a range from 200 nanometers to 200 micrometers (in some embodiments, in a range from 200 nanometers to 100 micrometers, 250 nanometers to 50 micrometers, 500 nanometers to 20 micrometers, 1 micrometers to 10 micrometers, or even 2 micrometers to 20 micrometers).
26D. The plurality of granules of any preceding D Exemplary Embodiment, wherein at least one of the first or second ceramic particles have a bimodal distribution of sizes.
27D. The plurality of granules of any preceding D Exemplary Embodiment, wherein at least one of the first or second inorganic binders is amorphous.
28D. The plurality of granules of any of Exemplary Embodiments 1D to 26D, wherein at least one of the first or second inorganic binders is partially crystallized.
29D. The plurality of granules of any preceding D Exemplary Embodiment, wherein at least one of the first or second alkali silicates is at least one of a cesium silicate, lithium silicate, a potassium silicate, or a sodium silicate.
30D. The plurality of granules of any preceding D Exemplary Embodiment, wherein the at least one of the first or second hardeners is amorphous.
31D. The plurality of granules of any preceding D Exemplary Embodiment, wherein the at least one of the first or second hardener is at least one of an aluminum phosphate, an aluminosilicate, a cryolite, a calcium salt (e.g., CaCl₂), or a calcium silicate.
32D. The plurality of granules of any preceding D Exemplary Embodiment, wherein the at least one of the first or second ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble.
33D. The plurality of granules of any preceding D Exemplary Embodiment, wherein the at least one of the first or second ceramic particles comprise mineral.
34D. The plurality of granules of any preceding D Exemplary Embodiment, wherein the granules further comprise at least one of a functional additive (e.g., rheology modifier (e.g., surfactant), durability modifier (e.g., nanosilica), and fluxing agent), organic binder, or pigment.
35D. The plurality of granules of any preceding D Exemplary Embodiment, wherein each respective granule has a density in a range from 0.5 g/cm³ to 3 g/cm³.
36D. The plurality of granules of any preceding D Exemplary Embodiment, wherein the granules are in at least one of the following shapes: cubes, truncated cubes, pyramids, truncated pyramids, triangles, tetrahedras, spheres, hemispheres, or cones.
37D. The plurality of granules of any preceding D Exemplary Embodiment, wherein each granule has a first face and a second face separated by a thickness.
38D. The plurality of granules of Exemplary Embodiment 37D, wherein at least some granules further comprise at least one of a straight or sloping wall.
39D. The plurality of granules of any preceding D Exemplary Embodiment, wherein the granules have a Stain Value not greater than 15 (in some embodiments, not greater than 10, 5, 4, 3, 2, 1, or even not greater than 0.5).
40D. The plurality of granules of any preceding D Exemplary Embodiment, further comprising at least one adhesion promoter.
41D. The plurality of granules of Exemplary Embodiment 40D, wherein the adhesion promotor comprises a polysiloxane.
42D. The plurality of granules of any preceding D Exemplary Embodiment, further comprising at least one dust suppressant.
43D. The plurality of granules of Exemplary Embodiment 42D, wherein the dust suppressant comprises an acrylic polymer comprising a quaternary ammonium moiety and a nonionic monomer.
44D. The plurality of granules of any preceding D Exemplary Embodiment, wherein the second ceramic particles are present and wherein the first and second ceramic particles are the same.
45D. The plurality of granules of any of Exemplary Embodiments 1D to 43D, wherein the second ceramic particles are present and wherein the first and second ceramic particles are different.
46D. The plurality of granules of any preceding D Exemplary Embodiment, wherein the first and second inorganic binders are the same.
47D. The plurality of granules of any of Exemplary Embodiments 1D to 46D, wherein the first and second inorganic binders are different.
1E. A roofing material (e.g., a shingle) comprising the plurality of granules of any preceding D Exemplary Embodiment.
2E. A roofing material of Exemplary Embodiment 1E having a Total Solar Reflectance (TSR) (as determined by the Total Solar Reflectance Test described in the Examples) of at least 60 (in some embodiments, at least 63, 65, or or even at least 70) %.
IF. A method of making the plurality of granules of any preceding D Exemplary Embodiment, the method comprising:

providing a plurality of ceramic cores;

coating each of the ceramic cores with a first layer precursor, wherein the first layer precursor comprises a first aqueous dispersion comprising the first ceramic particles, the first alkali silicate precursor, and the first hardener precursor;

coating each of the ceramic cores with a second layer precursor, wherein the second layer precursor comprises a second aqueous dispersion comprising the second alkali silicate precursor, the second hardener precursor, and optionally the second ceramic particles; and

curing the coated aqueous dispersion to provide the plurality of granules.
2F. The method of Exemplary Embodiment 1F, wherein the ceramic cores include solid ceramic cores.
3F. The method of either Exemplary Embodiment 1F or 2F, wherein the curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min.
4F. The method of any preceding F Exemplary Embodiment, wherein water is present in the first and second aqueous dispersions are each independently up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective aqueous dispersion.
5F. The method of any preceding F Exemplary Embodiment, wherein coating the ceramic core with the shell comprises fluidized bed coating.
6F. The method of Exemplary Embodiment 5F, wherein the fluidized bed coating comprises fluidizing ceramic cores, heating the bed of fluidized cores, and continuously feeding the aqueous dispersion into the fluidized bed.
7F. The method of Exemplary Embodiment 5F, wherein said feeding is over a period of time in a range from 5 minutes to 500 minutes.
8F. The method of Exemplary Embodiments 6F or 7F, wherein said heating is at a temperature in a range from 50° C. to 200° C.
1G. A plurality of granules comprising a ceramic core having an outer surface and a shell on and surrounding the core, wherein the shell comprises at least a first concentric, compositional gradient layer, wherein the first layer comprises first ceramic particles bound together with a first inorganic binder, wherein the first inorganic binder comprises reaction product of at least alkali silicate and hardener (in some embodiments further comprising alkali silicate itself), wherein the shell of each granule has a volume of at least 40 (in some embodiments, greater than 45, 50, 55, 60, 65, 70, 75, 80, or even greater than 85; in some embodiments, in a range from greater than 50 to 85, or even greater than 60 to 85) volume percent, based on the total volume of the respective granule, and wherein the granules have a minimum Total Solar Reflectance (TSR) (as determined by the Total Solar Reflectance Test described in the Examples) of at least 0.7 (in some embodiments, of at least 0.75, or even at least 0.8).
2G. The plurality of granules of Exemplary Embodiment 1G, wherein within the first compositional gradient layer there is a first average concentration of the first ceramic particles for a first region comprising at least 5 volume percent of the shell at a first average distance from the core of a granule, and a second average concentration of the first ceramic particles for a second region comprising at least 5 volume percent of the shell at a second, further average distance from the core of a granule, wherein the first average concentration is greater than the second average concentration.
3G. The plurality of granules of Exemplary Embodiment 1G or 2G, wherein within the first compositional gradient layer there is a first average volume percent porosity for a first region comprising at least 5 volume percent of the shell at a first average distance from the core of a granule, and a second average volume percent porosity for a second region comprising at least 5 volume percent of the shell at a second, further average distance from the core of a granule, wherein the first average volume percent porosity is greater than the second average volume percent porosity.
4G. The plurality of granules of any preceding G Exemplary Embodiment, further comprising a second layer. In some embodiments, the second layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself). In some embodiments, for a given granule, a third layer is disposed between the core and the first layer (in some embodiments, the third layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)). In some embodiments, for a given granule, a fourth layer is disposed between the first and second layers (in some embodiments, the fourth layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).
5G. The plurality of granules of any preceding G Exemplary Embodiment, wherein for a given granule, the first layer is one of contiguous or noncontiguous. For embodiments further comprising a second layer is (independently) one of contiguous or noncontiguous.
6G. The plurality of granules of Exemplary Embodiment 1G, wherein, the first layer has an average thickness at least 50 (in some embodiments, at least 75, 100, 250, 500, or even at least 1000; in some embodiments, in a range from 50 to 1000, 100 to 500, or even 150 to 250) micrometers. For embodiments having the second layer, the second layer has an average thickness that is less than the average thickness of the first layer. For embodiments having the second layer, in some embodiments, the second average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometers.
7G. The plurality of granules of any preceding G Exemplary Embodiment, wherein the ceramic cores include solid ceramic cores.
8G. The plurality of granules of any preceding G Exemplary Embodiment, wherein the core has a diameter of at least 200 micrometers (in some embodiments, at least 250 micrometers, 300 micrometers, 400 micrometers, 500 micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).
9G. The plurality of granules of any preceding G Exemplary Embodiment, wherein the core is at least one of a crystalline, glass, or a glass-ceramic.
10G. The plurality of granules of any preceding G Exemplary Embodiment, wherein the core comprises at least one of a silicate (e.g., silicate rock) (e.g., aluminosilicate (including aluminosilicate rock) and alkali aluminosilicate (including alkali aluminosilicate rock)), aluminate (including aluminate rock) (e.g., bauxite), or silica.
11G. The plurality of granules of any preceding G Exemplary Embodiment, wherein the shell has an average thickness of at least 50 (in some embodiments, at least 75, 100, 150, 200, 250, 300, 350, 400, 500, or even 750; in some embodiments, in a range from 50 to 750, 100 to 500, or even 200 to 500) micrometers.
12G. The plurality of granules of any preceding G Exemplary Embodiment, wherein the shell of each granule collectively comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the shell of the respective granule.
13G. The plurality of granules of any preceding G Exemplary Embodiment, wherein the first ceramic particles each have a longest dimension, wherein the granules each have a longest dimension, and wherein the longest dimension of each first ceramic particle for a given granule is no greater than 10% (in some embodiments, no greater than 20%) of the diameter of said given granule. For embodiments comprising second ceramic particles, in some embodiments, the second ceramic particles each have a longest dimension, wherein the granules each have a longest dimension, and wherein the longest dimension of each second ceramic particle for a given granule is no greater than 10% (in some embodiments, no greater than 20%) of the longest dimension of said given granule.
14G. The plurality of granules of any preceding G Exemplary Embodiment, wherein the first ceramic particles of each granule comprise no greater than 10 (in some embodiments, no greater than 5, 4, 3, 2, 1, or even zero) percent by weight TiO_{2,} based on the total weight of the granule. For embodiments comprising second ceramic particles, in some embodiments, the second ceramic particles of each granule comprise no greater than 10 (in some embodiments, no greater than 5, 4, 3, 2, 1, or even zero) percent by weight TiO₂, based on the total weight of the granule.
15G. The plurality of granules of any preceding G Exemplary Embodiment, wherein the first ceramic particles of each granule comprise no greater than 10 (in some embodiments, no greater than 5, 4, 3, 2, 1, or even zero) percent by weight pure Al₂O₃, based on the total weight of the granule. For embodiments comprising second ceramic particles, in some embodiments, the second ceramic particles of each granule comprise no greater than 10 (in some embodiments, no greater than 5, 4, 3, 2, 1, or even zero) percent by weight pure Al₂O₃, based on the total weight of the granule.
16G. The plurality of granules of any preceding G Exemplary Embodiment, wherein the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.
17G. The plurality of granules of any preceding G Exemplary Embodiment, wherein the first inorganic binder is present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule. For embodiments comprising second inorganic binder, in some embodiments, the second inorganic binder is present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule.
18G. The plurality of granules of any preceding G Exemplary Embodiment, wherein the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeters to 5 millimeters).
19G. The plurality of granules of any preceding G Exemplary Embodiment, wherein the first ceramic particles have an average size in a range from 200 nanometers to 200 micrometers (in some embodiments, in a range from 200 nanometers to 100 micrometers, 250 nanometers to 50 micrometers, 500 nanometers to 20 micrometers, 1 micrometers to 10 micrometers, or even 2 micrometers to 20 micrometers). For embodiments comprising second ceramic particles, in some embodiments, the second ceramic particles have an average size in a range from 200 nanometers to 200 micrometers (in some embodiments, in a range from 200 nanometers to 100 micrometers, 250 nanometers to 50 micrometers, 500 nanometers to 20 micrometers, 1 micrometers to 10 micrometers, or even 2 micrometers to 20 micrometers).
20G. The plurality of granules of any preceding G Exemplary Embodiment, wherein the first ceramic particles have a bimodal distribution of sizes. For embodiments comprising the second ceramic particles, in some embodiments, the second ceramic particles.
21G. The plurality of granules of any preceding G Exemplary Embodiment, wherein the first inorganic binder is amorphous. For embodiments comprising the second inorganic binder, in some embodiments, the second inorganic binder is amorphous.
22G. The plurality of granules of any of Exemplary Embodiments 1G to 20G, wherein the first inorganic binders is partially crystallized. For embodiments comprising the second inorganic binder, in some embodiments, the second inorganic binder is partially crystallized.
23G. The plurality of granules of any preceding G Exemplary Embodiment, wherein the first or second alkali silicates is at least one of a cesium silicate, lithium silicate, a potassium silicate, or a sodium silicate. For embodiments comprising the second inorganic binder, in some embodiments, the second inorganic binder is at least one of a cesium silicate, lithium silicate, a potassium silicate, or a sodium silicate.
24G. The plurality of granules of any preceding G Exemplary Embodiment, wherein the at least one of the first hardener is amorphous. For embodiments comprising the second hardener, in some embodiments, the second hardener is amorphous.
25G. The plurality of granules of any preceding G Exemplary Embodiment, wherein the first or second hardener is at least one of an aluminum phosphate, an aluminosilicate, a cryolite, a calcium salt (e.g., CaCl₂), or a calcium silicate. For embodiments comprising the second hardener, in some embodiments, the second hardener is at least one of an aluminum phosphate, an aluminosilicate, a cryolite, a calcium salt (e.g., CaCl₂), or a calcium silicate.
26G. The plurality of granules of any preceding G Exemplary Embodiment, wherein the at least one of the first or second ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble.
27G. The plurality of granules of any preceding G Exemplary Embodiment, wherein the first ceramic particles comprise mineral. For embodiments comprising the second ceramic particles, in some embodiments, the second ceramic particles comprise mineral.
28G. The plurality of granules of any preceding G Exemplary Embodiment, wherein the granules further comprise at least one of a functional additive (e.g., rheology modifier (e.g., surfactant), durability modifier (e.g., nanosilica), and fluxing agent), organic binder, or pigment.
29G. The plurality of granules of any preceding G Exemplary Embodiment, wherein each respective granule has a density in a range from 0.5 g/cm³ to 3 g/cm³.
30G. The plurality of granules of any preceding G Exemplary Embodiment, wherein the granules are in at least one of the following shapes: cubes, truncated cubes, pyramids, truncated pyramids, triangles, tetrahedras, spheres, hemispheres, or cones.
31G. The plurality of granules of any preceding G Exemplary Embodiment, wherein each granule has a first face and a second face separated by a thickness.
32G. The plurality of granules of Exemplary Embodiment 30G, wherein at least some granules further comprise at least one of a straight or sloping wall.
33G. The plurality of granules of any preceding G Exemplary Embodiment, wherein the granules have a Stain Value not greater than 15 (in some embodiments, not greater than 10, 5, 4, 3, 2, 1, or even not greater than 0.5).
34G. The plurality of granules of any preceding G Exemplary Embodiment, further comprising at least one adhesion promoter.
35G. The plurality of granules of Exemplary Embodiment 34G, wherein the adhesion promotor comprises a polysiloxane.
36G. The plurality of granules of any preceding G Exemplary Embodiment, further comprising at least one dust suppressant.
37G. The plurality of granules of Exemplary Embodiment 36G, wherein the dust suppressant comprises an acrylic polymer comprising a quaternary ammonium moiety and a nonionic monomer.
1H. A roofing material (e.g., a shingle) comprising the plurality of granules of any preceding G Exemplary Embodiment.
2H. A roofing material of Exemplary Embodiment 1H having a Total Solar Reflectance (TSR) (as determined by the Total Solar Reflectance Test described in the Examples) of at least 60 (in some embodiments, at least 63, 65, or or even at least 70) %.
1I. A method of making the plurality of granules of any preceding G Exemplary Embodiment, the method comprising:

providing a plurality of ceramic cores;

providing first and second first layer precursors, wherein the first precursor comprises first alkali silicate precursor, first hardener, and first ceramic particles, and wherein second precursor comprises second alkali silicate precursor, and second hardener, and optionally first or second ceramic particles;

coating each of the ceramic cores with the first and second first layer precursors, wherein initially the first layer precursor is applied at a higher rate than the second first layer precursor (where initially, for example, zero amount of the second first layer precursor is applied); and

curing the coated precursors to provide the plurality of granules.
2I. The method of Exemplary Embodiment 1I, wherein the ceramic cores include solid ceramic cores.
3I. The method of either Exemplary Embodiment 1I or 2I, wherein the curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min.
4I. The method of any preceding I Exemplary Embodiment, wherein water is present in the first and second first layer precursors, and each are independently up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective precursors.
5I. The method of any preceding I Exemplary Embodiment, wherein coating the ceramic core with the shell comprises fluidized bed coating.
6I. The method of Exemplary Embodiment 5I, wherein the fluidized bed coating comprises fluidizing ceramic cores, heating the bed of fluidized cores, and continuously feeding the aqueous dispersions into the fluidized bed.
7I. The method of Exemplary Embodiment 5I, wherein said feeding is over a period of time in a range from 5 minutes to 500 minutes.
8I. The method of Exemplary Embodiments 6I or 7I, wherein said heating is at a temperature in a range from 50° C. to 200° C.

Advantages and embodiments of this invention are further illustrated by the following examples, but the particular material and amounts thereof recited in these examples, as well as other conditions and details, should not be construed to unduly limit this invention. All parts and percentages are by weight unless otherwise indicated.

### EXAMPLES

### Examples 1-3 (Ex 1-3) and Illustrative Examples I and II

Examples 1-3 and Illustrative Examples I and II were prepared by applying a “base” coating layer on core mineral granules as follows: Grade #11 uncoated naturally occurring dacite mineral (obtained from 3M Company, St. Paul, Minn.) was screened to 14 or 18 grade using −14 mesh or −18 mesh U.S. sieve (see Table 1 (below) for grade size distributions), suspended in fluidized bed coater (obtained under the trade designation “GLATT GPCG-1” from Glatt, Weimar, Germany), and equilibrated at targeted temperature (25-30° C.) prior to application of coating slurry.

TABLE 1

| | Weight percent of material | | |
|---|---|---|---|
| U.S. Sieve Range | 11 Grade | 14 Grade | 18 Grade |
| +8M | 0-0.1 | 0 | 0 |
| −8 + 12 | 4-10 | 0-0.3 | 0-0.5 |
| −12 + 16 | 30-50 | 0.5-15 | 0-6 |
| −16 + 20 | 20-40 | 38-62 | 2-20 |
| −20 + 30 | 10-30 | 23-38 | 40-80 |
| −30 + 40 | 1-10 | 1-18 | 10-45 |
| −40M | 0-2 | 0-4 | 0-10 |

TABLE 2

| Material | Description | Source |
|---|---|---|
| STAR | Sodium silicate solution in water, wt. ratio | Obtained under trade designation |
| | SiO₂/Na₂O = 2.5, 37.1% solids content | “STAR” from PQ Corporation, |
| | | Malvern, PA |
| KSIL1 | Potassium silicate solution in water, wt. ratio | Obtained under trade designation |
| | SiO₂/Na₂O = 2.5, 29.1% solids content | “KSIL1” from PQ Corporation |
| METAMAX | Reactive metakaolin (anhydrous amorphous | Obtained under trade designation |
| | aluminosilicate) | “METAMAX” from BASF |
| | | Corporation, Florham Park, NJ |
| OPTIPOZZ | Reactive metakaolin (anhydrous amorphous | Obtained under trade designation |
| | aluminosilicate) | “OPTIPOZZ” from Burgess |
| | | Pigment Company, Sandersville, |
| | | GA |
| OPTIWHITE | Calcined kaolin clay | Obtained under trade designation |
| | | “OPTIWHITE” from Burgess |
| | | Pigment Company |
| CaCO₃ #10 | Calcium carbonate | Obtained under trade designation |
| | | “CaCO₃ #10” from Imerys, Inc., |
| | | Cockeysville, MD |
| RCL9 | Titanium dioxide | Obtained under trade designation |
| | | “RCL9” from Cristal Metals, |
| | | Woodridge, IL |
| MICRAL | Aluminum trihydrate, milled to d₅₀ = 3 micrometers | Obtained under trade designation |
| 632 | | “MICRAL 632” from J. M. Huber |
| | | Corporation, Edison, NJ |
| BS 60 | Silicone resin emulsion | Obtained under trade designation |
| | | “SILRES BS 60″ from Wacker |
| | | Chemical, Adrian, MI” |
| PSA57180 | Acrylate polymer and water | Obtained under trade designation |
| POLYMER | | “PSA57180 POLYMER” from |
| | | 3M Company, St. Paul, MN |

Slurries for coating were formulated using raw materials and formulations listed in Table 2 (above) and Table 3 (below), respectively.

TABLE 3

| | | Illustrative | Illustrative | | | Illustrative | Illustrative |
|---|---|---|---|---|---|---|---|
| | EX 1 | EX I | EX II | EX 2 | EX 3 | EX III | EX IV |
| 1st coat components, wt. % | | | | | | | |
| STAR | 14.3 | 14.3 | 18.9 | 18.9 | 18.9 | 6.5 | 12.5 |
| METAMAX | 5.3 | 5.3 | 0.0 | 0.0 | 0.0 | 0.0 | 0.0 |
| OPTIPOZZ | 0.0 | 0.0 | 7.0 | 7.0 | 7.0 | 0.0 | 0.0 |
| OPTIWHITE | 9.0 | 9.0 | 15.8 | 15.8 | 15.8 | 19.5 | 16.5 |
| CaCO₃ #10 | 18.0 | 18.0 | 15.8 | 15.8 | 15.8 | 0.0 | 0.0 |
| MICRAL 632 | 0.0 | 0.0 | 0.0 | 0.0 | 0.0 | 19.5 | 16.5 |
| RCL9 | 0.0 | 0.0 | 4.5 | 4.5 | 4.5 | 4.5 | 4.5 |
| Water | 53.4 | 53.4 | 38.0 | 38.0 | 38.0 | 50.0 | 50.0 |
| 2nd coat components, wt. % | | | | | | | |
| STAR | 29.7 | no 2nd coat | no 2nd coat | 0.0 | 0.0 | no 2nd coat | no 2nd coat |
| KSIL1 | 0 | applied | applied | 30.1 | 29.1 | applied | applied |
| ASP 172 | 9.6 | | | 0 | 0.0 | | |
| OPTIWHITE | 4.3 | | | 12.1 | 11.6 | | |
| OPTIPOZZ | 0 | | | 4.22 | 4.1 | | |
| MICRAL 632 | 0 | | | 0 | 0.0 | | |
| RCL9 | 0 | | | 0 | 3.9 | | |
| Water | 56.4 | | | 53.1 | 51.3 | | |
| Firing temperature, ° C. | 425 | 425 | 450 | 450 | 450 | 450 | 450 |
| Post-Treatment Components, wt. % | | | | | | | |
| Water | 81.3 | 81.3 | 93.0 | 93.0 | 93.0 | 0.0 | 0.0 |
| BS60 | 7.0 | 7.0 | 1.8 | 1.8 | 1.8 | 0.0 | 0.0 |
| PSA57180 Polymer | 11.7 | 11.7 | 5.3 | 5.3 | 5.3 | 0.0 | 0.0 |
| Properties Tested | | | | | | | |
| Pore vol. % | not tested | not tested | not tested | not tested | not tested | 41 | 29 |
| Water Repellency, min | 100 | 80 | 0 | >30 | >30 | not tested | not tested |
| TSR cup | 0.765 | 0.777 | 0.780 | 0.780 | 0.780 | 0.80 | 0.74 |
| Dust, mg/m³ | 8.2 | 311* | not tested | not tested | not tested | not tested | not tested |

*meter maxed out

The slurries were made generally as follows: First, structural filler (“MICRAL 632” or “CaCO3 #10”), color extender (“OPTIWHITE”) and pigment (“RCL9”), if needed, were combined. Next, hardener (“METAMAX,” “OPTIPOZZ,” or “ASP 172”) was combined with liquid silicate (“STAR” or “KSIL1”) and additional water and stirred vigorously for 10 minutes. Then, the dry powdered portion was combined with the liquid part and mixed via high shear using a Cowles blade at 500 rpm for at least 15 minutes. Slurry was maintained in suspension via continuous stirring while being pumped into fluidized bed coater.

In the coater, the slurry spray rate was kept as high as possible without accumulating moisture in the product bed. Product temperature was kept in the range 26-32° C., the atomizing pressure was 20-35 psi (138-241 kPa), the fluidizing air was 400-600 fpm (122-183 meters per minute), and the spray rate was 40-75 g/min. The fluidizing air was generally kept as low as possible while maintaining fluidized bed motion. Typical settings of batch fluid bed coater that was used as outlined below.

Solids starting charge, grams 1000-1200

Air velocity, mpm×100 0.183-0.305

Process Temp. setpoint, ° C. 60-80

Process Temp. reading, ° C. 60-80

Product Temp., ° C. 25-30

D/P across filter, range 50-100

D/P across material bed, range 50-150

R/H in exhaust air, range, % 30-40

Atomizing air pressure, kPa 103-138

Pump flow rate, timed, g/min. 30-50

Filter shaking on, y/n y

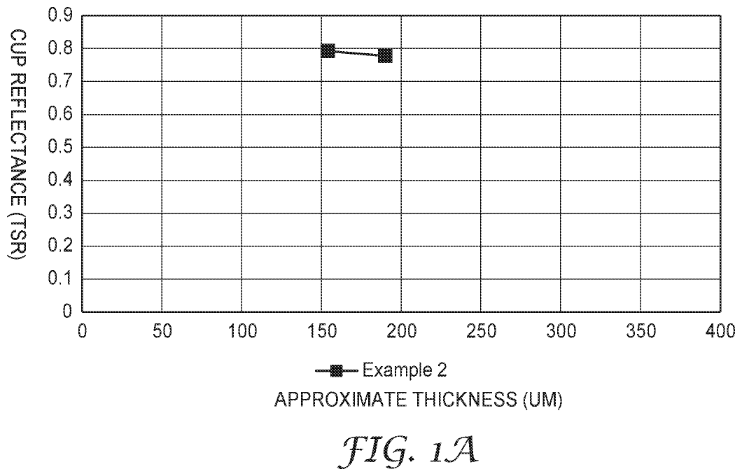

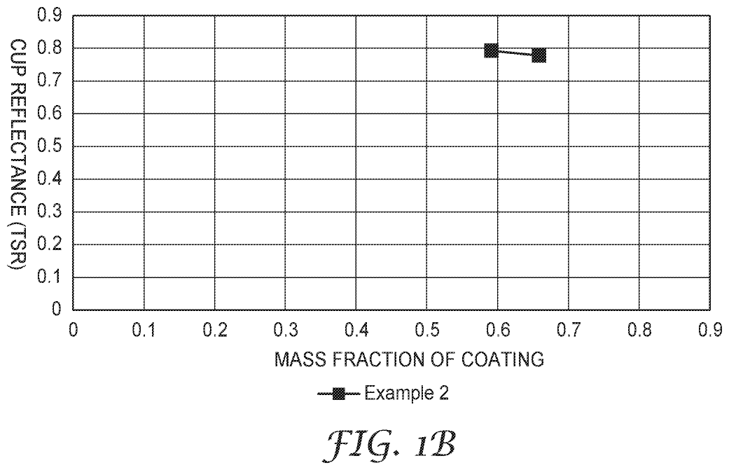

For a batch of 1-2 kilograms core granules, the coating process to form base coat of final thickness took about 1-2 hour. The final thickness (i.e., the “optimum optical thickness”) was determined by plotting total solar reflectance (TSR) versus amount of coating (thickness in micrometers or amount of coating expressed as estimated weight fraction of coated granule). Once the graph of TSR versus amount of coating applied reaches a plateau, further increase in coating thickness was inexpedient for that combination of core granules and coating slurry composition. FIGS. 1A and 1B show TSR vs. coating thickness and TSR vs. coating fraction, respectively, for Example 2.

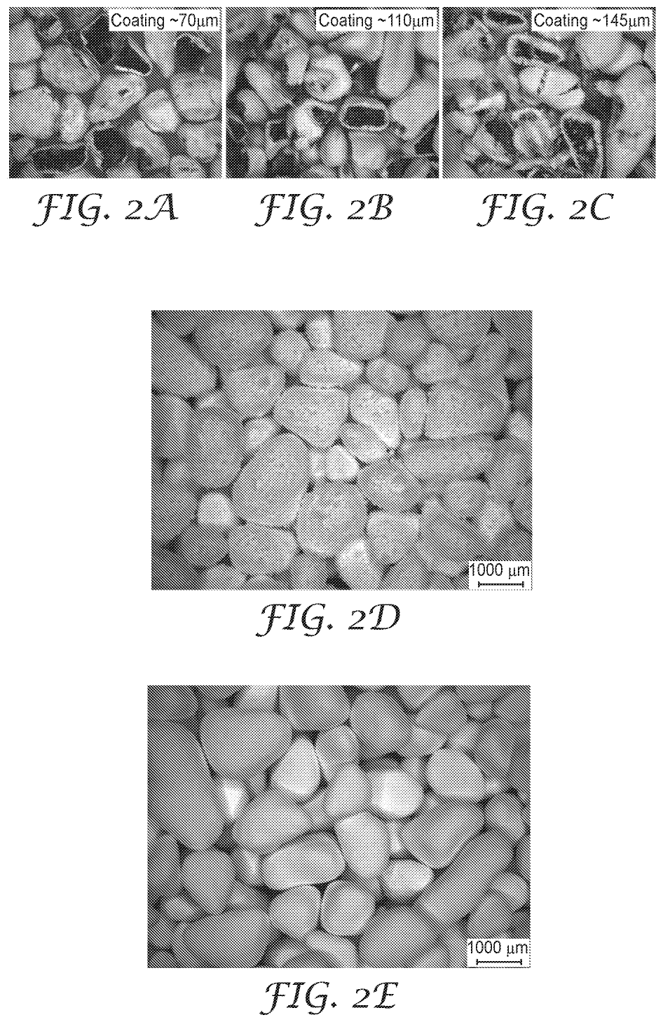

Final thickness of the first coating layer of Examples 1-3 and Illustrative Example I and II ranged from 200 to 400 micrometers, which corresponded to about 50-85 wt. % of the whole granule construction. FIGS. 2A-C show optical images of bright white core-shell granules of Example 2 (base coating thicknesses corresponding to a 0.2-0.3 coating fraction) at various stages of the coating process.

On Examples 1-3 a second layer was designed as a final thin coating (about 10-20 micrometers) which was applied on top of the base coating layer to decrease total surface area of the granule by eliminating open porosity and dust. Seal coat was applied in fluid bed coater as final coating with the following parameters of the run: product temperature was kept in the range 30-35° C., the atomizing pressure was 25 psi (172 kPa), the fluidizing air was 12-13 fpm (about 3.8 meters per minute), and the spray rate was 6-7 g/min.

Illustrative Example I represented granules of Example 1 on which no second coating layer was applied. Illustrative Example II represented granules of Examples 2 and 3 on which no second coating layer was applied.

Once the coating process was complete, granules were taken out of the coater and placed into a batch oven, where they were heated with heating rate of 9.5° C./min. up to 425° C. and cured at that temperature for 4 hours for Example 1 and Illustrative Example I. For Examples 2 and 3 and Illustrative Example II, they were heated with a heating rate of 2° C./min up to 450° C. and subsequently cured at that temperature for 3 hours.

FIGS. 2D and 2E show optical images of Illustrative Example II and Example 2 respectively showing the impact of adding a second coating layer per Example 2.

Heated granules were tested for cup brightness and dust using the “Method For Determining Reflectivity (Total Solar reflectivity (TSR))” and “Method for Determining Dust of Granules,” respectively.

After the heating step, the coated and cured granules were post treated with an adhesion promoting solution. The adhesion promoting solution (prepared using formula according to Table 3 above) was applied to the surfaces of the granules by mixing 1000 grams of granules with 36.9 grams of the adhesion promoting solution in a 1-gallon (3.79 L) can on a paint shaker for 5 minutes. Treated granules were tested using the “Water Repellency Test.”

### Illustrative Examples III and IV

Illustrative Examples III and IV are examples of formulas that could be used as a first and second layer, respectively, on the core. These examples were prepared by mixing the ingredients according to the formula in Table 3 (above), then drying in a pan at 80° C. in oven, followed by crushing and screening to granule sizes of 425-2000 micrometers. Screened fraction of the granules was placed into a batch oven, where they were heated with heating rate of 2° C./min. up to 450° C. and subsequently cured at that temperature for 3 hours. These samples were used to test porosity of materials. The results of all tests are summarized in Table 3, above.

Foreseeable modifications and alterations of this disclosure will be apparent to those skilled in the art without departing from the scope and spirit of this invention. This invention should not be restricted to the embodiments that are set forth in this application for illustrative purposes.

1. A plurality of granules comprising a ceramic core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener, wherein the second layer comprises a second inorganic binder and optionally second ceramic particles, wherein if present the second ceramic particles are bound together with the second inorganic binder, wherein the second inorganic binder comprises reaction product of at least alkali silicate and hardener, wherein for a given granule, the first ceramic particles are present in a first weight percent with respect to the total weight of the first layer and the second ceramic particles are present in the second layer of the same granule in a second weight percent with respect to the total weight of the second layer, wherein for a given granule, the first weight percent is greater than the second weight percent, wherein the shell of each granule collectively has a volume of at least 40 volume percent, based on the total volume of the respective granule, and wherein the granules have a minimum Total Solar Reflectance of at least 0.7.

2. The plurality of granules of claim 1, wherein for a given granule, the first weight percent is in a range from 50 to 80 weight percent with respect to the first layer, and wherein for the same granule, the second weight percent is in a range from 0 to 50 weight percent with respect to the second layer.

3. The plurality of granules of claim 1, wherein for a given granule, the first layer has a first volume percent porosity and the second layer of the same granule has a second volume percent porosity, wherein the first volume percent porosity of the first layer is greater than the second volume percent porosity of the respective second layer.

4. The plurality of granules of claim 1, wherein for a given granule, the first and second layers have a first and second average thickness respectively, and wherein for the same granule, the first average thickness is greater than the second average thickness.

5. The plurality of granules of claim 4, wherein, the first average thickness is at least 75 micrometers, and wherein, the second average thickness is in a range from 1 to 50 micrometers.

6. The plurality of granules of claim 1, wherein the granules have a Tumble Toughness Value of least 70 before immersion in water and at least 50 after immersion in water at 20° C.±2° C. for two months.

7. The plurality of granules of claim 1, wherein the at least one of the first or second ceramic particles comprise mineral.

8. The plurality of granules of claim 1, wherein the granules have a Stain Value not greater than 15.

9. The plurality of granules of claim 1, further comprising at least one adhesion promoter.

10. A roofing material comprising the plurality of granules of claim 1 having a Total Solar Reflectance of at least 60%.

11. A method of making the plurality of granules of claim 1, the method comprising:
providing a plurality of ceramic cores;
coating each of the ceramic cores with a first layer precursor, wherein the first layer precursor comprises a first aqueous dispersion comprising the first ceramic particles, the first alkali silicate precursor, and the first hardener precursor;
coating each of the ceramic cores with a second layer precursor, wherein the second layer precursor comprises a second aqueous dispersion comprising the second ceramic particles, the second alkali silicate precursor, and the second hardener precursor; and
curing the coated aqueous dispersion to provide the plurality of granules, wherein the curing is conducted at least in part at a temperature in a range from 40° C. to 500° C.

12. The method of claim 11, wherein coating the ceramic core with the shell comprises fluidized bed coating.

13. A plurality of granules comprising a ceramic core having an outer surface and a shell on and surrounding the core, wherein the shell comprises at least first and second concentric layers, wherein the first layer is closer to the core than the second layer, wherein the first layer comprises first ceramic particles bound together with a first inorganic binder, wherein the first inorganic binder comprises reaction product of at least alkali silicate and hardener, wherein the second layer comprises a second inorganic binder and optionally second ceramic particles, wherein if present the second ceramic particles are bound together with the second inorganic binder, wherein the second inorganic binder comprises reaction product of at least alkali silicate and hardener, wherein for a given granule, the first layer has a first volume percent porosity and the second layer of the same granule has a second volume percent porosity, wherein the first volume percent porosity of the first layer is greater than the second volume percent porosity of the respective second layer, wherein the shell of each granule collectively has a volume of at least 40 volume percent, based on the total volume of the respective granule, and wherein the granules have a minimum Total Solar Reflectance of at least 0.7.

14. The plurality of granules of claim 13, wherein for a given granule, the first volume percent porosity is in a range from 25 to 50 volume percent with respect to the first layer, and wherein for the same granule, the second volume percent porosity is in a range from 0 to 20 volume percent with respect to the second layer.

15. A plurality of granules comprising a ceramic core having an outer surface and a shell on and surrounding the core, wherein the shell comprises at least a first concentric, compositional gradient layer, wherein the first layer comprises first ceramic particles bound together with a first inorganic binder, wherein the first inorganic binder comprises reaction product of at least alkali silicate and hardener, wherein the shell of each granule has a volume of at least 40 volume percent, based on the total volume of the respective granule, wherein the granules have a minimum Total Solar Reflectance of at least 0.7, wherein within the first compositional gradient layer there is a first average concentration of the first ceramic particles for a first region comprising at least 5 volume percent of the shell at a first average distance from the core of a granule, and a second average concentration of the first ceramic particles for a second region comprising at least 5 volume percent of the shell at a second, further average distance from the core of a granule, and wherein the first average concentration is greater than the second average concentration.
